(19) United States
(12) Patent Application Publication
(10) Pub. No.: US 2023/0060263 A1
(43) Pub. Date: Mar. 2, 2023

(54) ELECTRIC VEHICLE CHARGING CONTROL DEVICE AND METHOD THEREOF

(71) Applicants: Hyundai Motor Company, Seoul (KR); Kia Corporation, Seoul (KR)

(72) Inventors: Gun Goo Lee, Suwon-si (KR); Dae Gun Jin, Suwon-si (KR)

(73) Assignees: Hyundai Motor Company, Seoul (KR); Kia Corporation, Seoul (KR)

(21) Appl. No.: 17/812,424

(22) Filed: Jul. 13, 2022

(30) Foreign Application Priority Data
Aug. 26, 2021 (KR) 10-2021-0113460

(51) Int. Cl. H02J 7/00; B60L 53/10

(52) U.S. Cl. CPC H02J 7/007194; B60L 53/10; H02J 7/007182; H02J 7/0048; H02J 7/00309

(57) ABSTRACT

The present disclosure relates to an electric vehicle charging control device and method thereof capable of changing a charging method according to the temperature of a battery mounted in an electric vehicle to maximize the efficiency of fast charging while preventing battery deterioration and accidents. The electric vehicle charging control device may be formed in the electric vehicle and include a temperature sensor configured to sense a temperature of a battery to be charged and generate temperature information, a processor, and a memory coupled to the processor. The memory may be configured to store program commands that are executable by the processor, and cause the processor to perform fast charging of the battery by using a maximum current value that maintains a temperature less than a present second threshold temperature when the temperature information is greater than or equal to a preset first threshold temperature.

### CROSS REFERENCE TO RELATED APPLICATION

The present application claims, under 35 U.S.C. § 119(a), the benefit of Korean Patent Application No. 10-2021-0113460, filed Aug. 26, 2021, the entire contents of which is incorporated herein by reference in its entirety.

### BACKGROUND

### Technical Field

Embodiments of the present disclosure relate to electric vehicle charging control devices and methods thereof and, more particularly, to charging control devices and methods thereof for changing a charging method according to the temperature of a battery mounted in an electric vehicle.

### Description of the Related Art

An electric vehicle is a vehicle that uses a battery engine operated by an electric energy output from a battery. The battery engine often includes a battery capable of charging and discharging. Since an electric vehicle uses a battery capable of charging and discharging as its main power source, there is no exhaust gas and very little noise.

The performance of an electric vehicle battery directly affects the performance of the vehicle. Continuous use of the battery used in an electric vehicle may lead to deterioration of the battery, degrading its performance. When the battery deteriorates, problems may occur such as a decrease in traveling distance and a decrease in output when the vehicle is accelerating, even if the State Of Charge (SOC) is the same.

It is important to specially manage electric vehicle batteries in order to reduce or delay deterioration, since early replacement of the battery due to rapid deterioration can be a financial burden to a user and, in turn, can drastically reduce satisfaction with the vehicle. In particular, when the battery is exposed to high temperatures, the high temperatures not only accelerate deterioration, but can lead to ignition or explosion. Therefore, the temperature of the battery must be managed to extend the battery life of an electric vehicle and to prevent accidents.

On the other hand, in order to quickly charge the battery of an electric vehicle, a high current must be supplied to the battery, which may cause an increase in the temperature of the battery. Therefore, it is common to slowly charge the battery when the temperature of the battery exceeds a certain value. However, if the temperature of the battery for converting the fast charging to the slow charging is set to a value too low, a charging time becomes longer and the level of customer's satisfaction is lowered, and if it is set to a value that is too high, it may cause battery deterioration or explosion.

### SUMMARY

Embodiments of the present disclosure have been made in view of the above problems, and it is an object of the present disclosure to provide an electric vehicle charging control device and method thereof capable of maximizing the efficiency of fast charging while preventing battery deterioration and accidents.

According to an exemplary embodiment of the present disclosure, an electric vehicle charging control device is disclosed, comprising: a temperature sensor configured to sense a temperature of a battery to be charged and generate temperature information, a processor, and a memory coupled to the processor, wherein the memory is configured to store program commands that are executable by the processor, and cause the processor to perform fast charging of the battery by using a maximum current value that maintains less than a preset second threshold temperature when the temperature information is greater than or equal to a preset first threshold temperature.

According to an exemplary embodiment, the program commands are further configured to cause the processor to increase a current value set when the temperature information is sensed to be greater than or equal to the first threshold temperature, and terminate the increase of the current value when the temperature information reaches the preset second threshold temperature.

According to an exemplary embodiment, the program commands are further configured to cause the processor to terminate the fast charging when a voltage of the battery reaches a preset cut-off voltage as the battery is quickly charged using the maximum current value.

According to an exemplary embodiment, the program commands are further configured to cause the processor to start constant-voltage charging when the cut-off voltage is reached using the maximum current value.

According to an exemplary embodiment, the program commands are further configured to cause the processor to start slow charging when a current provided to the battery corresponds to a preset slow charging current after the constant-voltage charging.

According to an exemplary embodiment, the program commands are further configured to cause the processor to terminate the fast charging when the temperature information is greater than or equal to the second threshold temperature.

According to an exemplary embodiment, the program commands are further configured to cause the processor to restart the fast charging when the temperature information becomes less than the second threshold temperature.

According to another exemplary embodiment of the present disclosure, a method for controlling charging of an electric vehicle performed in an electric vehicle charging control device is disclosed. The method includes setting a maximum current value that maintains less than a present second threshold temperature when a temperature of a battery to be charged is greater than or equal to a preset first threshold temperature; and performing fast charging of the battery using the maximum current value.

According to an exemplary embodiment, the setting the maximum current value may further include increasing a current value set when temperature information is sensed to be greater than or equal to the first threshold temperature; and terminating the increase of the current value when the temperature information reaches the second threshold temperature.

According to an exemplary embodiment, the method for controlling charging of the electric vehicle may further include terminating the fast charging when the voltage of the battery reaches a preset cut-off voltage as the battery is quickly charged using the maximum current value.

According to an exemplary embodiment, the terminating the fast charging may further include starting constant-voltage charging when the cut-off voltage is reached using the maximum current value.

According to an exemplary embodiment, the terminating the fast charging may further include starting slow charging when a current supplied to the battery corresponds to a preset slow charging current after the constant-voltage charging.

According to an exemplary embodiment, the method for controlling charging of an electric vehicle may further include terminating the fast charging when temperature information is sensed to be greater than or equal to the second threshold temperature.

According to an exemplary embodiment, the method for controlling charging of the electric vehicle may further include restarting the fast charging when temperature information is sensed to be less than the second threshold temperature.

According to embodiments of the present disclosure, it is possible to maximize the efficiency of fast charging while preventing battery deterioration and accidents.

### BRIEF DESCRIPTION OF THE DRAWINGS

In order to more fully understand the drawings recited in the detailed description of the disclosure, a brief description of each drawing is provided.

FIG. 1 is a block diagram of an electric vehicle charging control device according to an embodiment of the present disclosure.

FIG. 2 is a view illustrating electric vehicle charging control information according to an embodiment of the present disclosure.

FIG. 3 is a view illustrating an electric vehicle charging control result according to an embodiment of the present disclosure.

FIG. 4 is a flowchart of a method for controlling charging of an electric vehicle according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although the terms such as first, second, etc. are used herein to describe various members, regions, layers, parts, and/or components, it is to be understood that these members, components, regions, layers, parts, and/or components should not be limited by these terms. These terms do not imply a specific order, upper and lower, or superiority, and are used only to distinguish one member, region, part, or component from another member, region, part, or component. Accordingly, the first member, region, part, or component to be described below may refer to the second member, region, part, or component without departing from the technical sprit of the present disclosure. For example, without departing from the scope of the present disclosure, a first component may be referred to as a second component, and similarly, the second component may also be referred to as a first component.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Exemplary embodiments according to the technical spirit of the present disclosure are provided to more completely explain the technical spirit of the present disclosure to those of ordinary skill in the art, and the following embodiments may be modified in various other forms, and the scope of the technical spirit of the present disclosure is not limited to the following embodiments. Rather, these embodiments are provided to more fully complete the present disclosure, and to fully convey the technical spirit of the present disclosure to those skilled in the art.

Unless defined otherwise, all terms used herein, including technical and scientific terms, have the same meaning as commonly understood by one of ordinary skill in the art to which the concept of the present disclosure belongs. In addition, commonly used terms as defined in the dictionary should be construed as having a meaning consistent with their meaning in the context of the relevant technology, and it should not be construed in an overly formal sense unless explicitly defined herein.

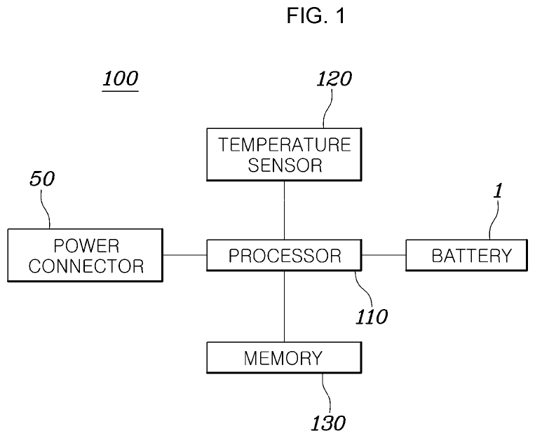

FIG. 1 is a block diagram of an electric vehicle charging control device according to an exemplary embodiment of the present disclosure.

An electric vehicle charging control device 100, according to an embodiment of the present disclosure, may include a processor 110, a temperature sensor 120, a memory 130, a battery 140, and a power connector 150.

The electric vehicle charging control device 100 may be formed inside an electric vehicle. The electric vehicle charging control device 100 may be formed as a separate device distinguished from other electric components of the electric vehicle or may be formed as a functional component of a Battery Management System (BMS).

The temperature sensor 120 may be configured to sense a temperature and, in particular, may be configured to sense the temperature of the battery 140 to generate temperature information (T_{b}). That is, the temperature information (T_{b}) may be the temperature of the battery 120 measured by the temperature sensor 120. The temperature sensor 120 may be configured to sense the temperature of the battery 140 periodically or always for a preset time.

The battery 140 may be configured to supply the power for driving and other operations of the electric vehicle, and may include, for example, a lithium ion battery.

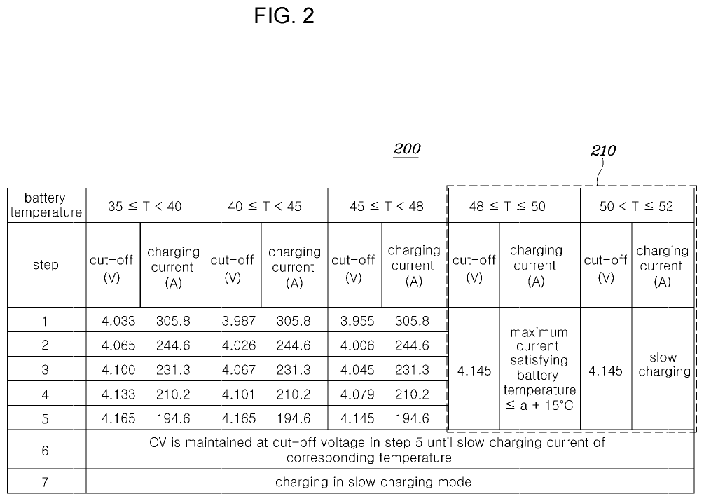

The memory 130 may be configured to store charging control information (which is illustrated in FIG. 2) for the operation of the electric vehicle charging control device 100 and program commands, and it may be a memory device, such as a hard disk and a Solid-State Drive (SSD). In particular, the memory 130 may be configured to store a program command executed under the control of the processor 110, and the program command may relate to an operation of controlling the charging of the battery 140 using the temperature, voltage, etc. of the battery 140.

The power connector 150 may include a power connection terminal connected to commercial power. The power supplied through the power connector 150 may be charged in the battery 140 and used to drive an electric vehicle.

The processor 110 may be configured to execute the program command stored in the memory 130 to charge the battery 140 with the power supplied from the power connector 150. In this case, the charging control information, the Temperature Information (T_{b}), the voltage of the battery 140, and the like, stored in the memory 130, may be used. Hereinafter, an operation in which the battery 140 is charged according to the execution of the program command by the processor 110 will be described in detail with reference to FIG. 2.

FIG. 2 is a view illustrating electric vehicle charging control information according to an exemplary embodiment of the present disclosure.

Referring to FIG. 2, the electric vehicle charging control information 200 exemplifies the relationship of a charging current value [A] with respect to a battery temperature (i.e., temperature information, T) and a cut-off voltage (Cut-off) [V] is illustrated.

According to the electric vehicle charging control information 200, when the temperature information (T) is (a+3) degrees and the voltage of the battery 140 is (b+0.032) [V], the battery 140 can be charged through (c−61.2) [A]. Similarly, when the temperature information (T) is (a+7) degrees and the voltage of the battery 140 is (d+0.114) [V], the battery 140 can be charged through a current of (e−95.6) [A].

In addition, according to the electric vehicle charging control information 200, when the temperature information (T) is (a+3) degrees and the voltage of the battery 140 reaches (b+0.132) [V], the battery 140 may be charged with a Constant Voltage (CV) until the current supplied to the battery 140 corresponds to a preset slowing current (e.g., j [A]). That is, under this condition, the battery 140 may be charged while maintaining (b+0.132) [V] until the current supplied to the battery 140 changes from (c−111.2) [A] to (j) [A].

The above description relates to the charging operation of the battery 140 when the temperature information (T_{b}) is less than a present first threshold temperature (Tₜₕ₁, (a+13) degrees in the electric vehicle charging control information 200 of FIG. 2). When the temperature information (T_{b}) is greater than or equal to the first threshold temperature, the battery 140 may be operated in a high-temperature fast charging mode 210 to exhibit the highest charging efficiency while preventing deterioration.

That is, when the temperature information (T_{b}) is greater than or equal to the first threshold temperature (Tₜₕ₁), the battery 140 may be charged through the maximum current (Iₘₐₓ-Tₜₕ₂), satisfying that the temperature of the battery 140 is less than or equal to the preset second threshold temperature (Tₜₕ₂, (a+15) degrees in the electric vehicle charging control information 200 of FIG. 2).

Here, the maximum current may be a value that is experimentally preset and stored in the memory 130. Alternatively, the maximum current may be the current when the temperature information (T_{b}) reaches the second threshold temperature (Tₜₕ₂) after the current supplied to the battery 140 continues to increase when the temperature information (T_{b}) is sensed to be greater than or equal to the first threshold temperature (Tₜₕ₁). Accordingly, when the temperature information (T_{b}) is greater than or equal to the first threshold temperature (Tₜₕ₁), the current supplied to the battery 140 may continue to increase until the temperature information (T_{b}) becomes the second threshold temperature (Tₜₕ₂), and the battery 140 may be charged quickly until the temperature information (T_{b}) becomes the second threshold temperature (Tₜₕ₂) through the input maximum current (Iₘₐₓ-Tₜₕ₂) or until the voltage of the battery 140 becomes a preset cut-off voltage.

On the other hand, under the condition that the temperature information (T_{b}) is greater than or equal to the first threshold temperature (Tₜₕ₁) and less than the second threshold temperature (Tₜₕ₂), when the voltage of the battery 140 reaches the cut-off voltage ((h) [V] in the example of FIG. 2) during fast charging with the maximum current, the battery 140 may be charged with a Constant-Voltage (CV) until the current supplied to the battery 140 becomes a slow charging current (e.g., (j) [A]). In addition, when the current supplied to the battery 140 reaches the slow charging current, the battery 140 may be slowly charged through the slow charging current.

In addition, when the temperature information (T_{b}) is lowered from the first threshold temperature (Tₜₕ₁) or more to less than the first threshold temperature (Tₜₕ₁), the current may be increased such that the current corresponding to the electric vehicle charging control information 200 is supplied to the battery 140 again.

Also, when the temperature information (T_{b}) is greater than or equal to the second threshold temperature (Tₜₕ₂), the slow charging current may be supplied to the battery 140. As a result, the fast charging of the battery 140 is terminated, and slow charging may be performed. This is to prevent the temperature of the battery 140 from rising any longer. In addition, when the temperature information (T_{b}) is less than the second threshold temperature (Tₜₕ₂), the maximum current that maintains less than the second threshold temperature (Tₜₕ₂) may be supplied to the battery 140 to resume the fast charging.

As described above, the processor 110 may be configured to execute the program commands stored in the memory 130 and may be configured to determine whether to charge quickly, charge at a constant voltage or charge slowly by using the temperature and voltage of the battery 140. In this case, by setting the number of the threshold temperature for fast charging to two, the temperature range at which fast charging is possible can be maintained to the maximum, thereby maximizing the charging efficiency of the electric vehicle and preventing deterioration of the battery 140.

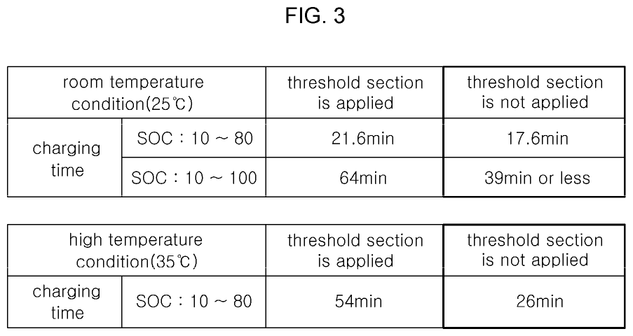

FIG. 3 is a view illustrating an electric vehicle charging control result according to an exemplary embodiment of the present disclosure.

Referring to FIG. 3, the result of comparing the charging time when the battery 140 is charged by applying the threshold section 210 of the electric vehicle charging control information 200 illustrated in FIG. 2 and the charging time when the battery 140 is charged without applying the threshold section 210 is illustrated.

First, when the battery temperature at the start of charging is at room temperature (that is, 25° C.), it can be confirmed that the charging time, up to 80% State of Charge (SOC), is 6 minutes faster when the threshold section is applied than when the threshold section is not applied.

In addition, if the battery temperature at the start of charging is at room temperature (that is, 25° C.), it can be confirmed that the charging time to 100% SOC is 25 minutes faster when the threshold section is applied than when the threshold section is not applied.

In addition, if the battery temperature at the start of charging is a high temperature condition (that is, 35° C.), it can be confirmed that the charging time up to 80% SOC is 28 minutes faster when the threshold section is applied than when the threshold section is not applied.

Therefore, since the electric vehicle charging control operation, according to an exemplary embodiment of the present disclosure can maximize the efficiency of fast charging while preventing the temperature increase of the battery 140, it is possible to reduce the charging speed while preventing the deterioration of the battery 140, so that the user's electric vehicle satisfaction can be increased.

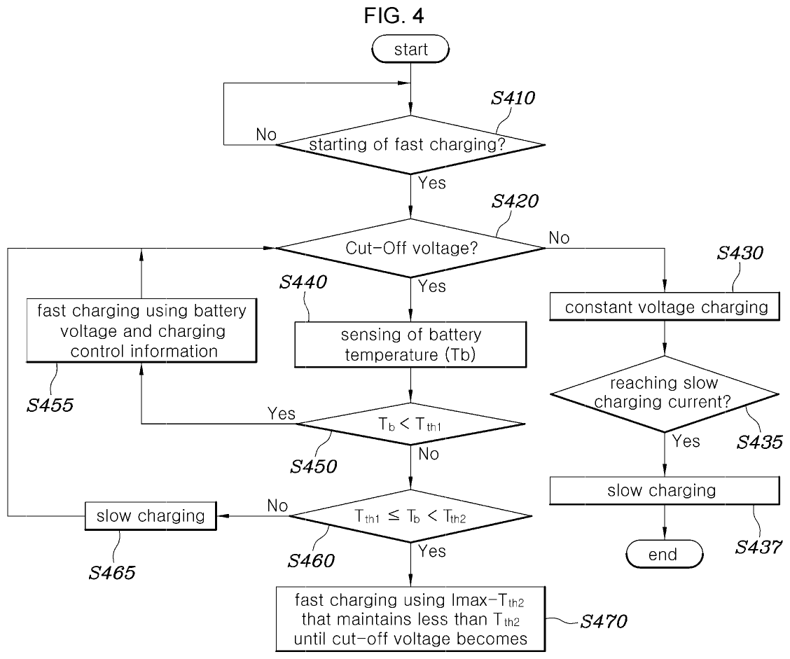

FIG. 4 is a flowchart of a method for controlling the charging of an electric vehicle according to an exemplary embodiment of the present disclosure.

Hereinafter, a method for controlling the charging of an electric vehicle according to an exemplary embodiment of the present disclosure will be described with reference to FIG. 4. Each of the steps described below may be performed by each component (particularly, the processor 110) of the electric vehicle charging control apparatus 100 described with reference to FIG. 1, but for convenience of understanding and explanation, it will be collectively described as being performed by the electric vehicle charging control device 100.

In step S410, the electric vehicle charging control device 100 may be configured to determine whether fast charging is started. For example, the electric vehicle charging control device 100 may be configured to recognize that fast charging is started when a commercial voltage is applied to the power connector 150.

In step S420, the electric vehicle charging control device 100 may be configured to determine whether the current voltage of the battery 140 is greater than or equal to a cut-off voltage preset as corresponding to a current temperature (i.e., temperature information) of the battery 140 and, particularly, whether the current voltage of the battery 140 is greater than or equal to the cut-off voltage set to terminate fast charging. For example, in the electric vehicle charging control information 200 illustrated in FIG. 2, when the temperature information is (a+2) degrees and the voltage of the battery 140 is (b+0.132) [V], the electric vehicle charging control device 100 may be configured to determine that the current voltage is greater than or equal to the cut-off voltage. As another example, in the electric vehicle charging control information 200 illustrated in FIG. 2, if the temperature information is (a+12) degrees and the voltage of the battery 140 is (f+0.19) [V], the electric vehicle charging control device 100 may be configured to determine that the current voltage is greater than or equal to the cut-off voltage.

In step S430, when it is determined that the current-voltage of the battery 140 is greater than or equal to the cut-off voltage, the electric vehicle charging control device 100 may be configured to charge the battery 140 at a Constant Voltage (CV charging).

In step S435, when it is determined that the current supplied to the battery 140 for constant-voltage charging reaches a preset buffer current (e.g., (j) [A]), the electric vehicle charging control device 100 may be configured to charge the battery 140 slowly (S437).

In step S440, when the electric vehicle charging control device 100 determines that the current voltage of the battery 140 is less than the cut-off voltage, the electric vehicle charging control device 100 may be configured to check the current temperature of the battery 140 for fast charging of the battery 140. For example, the electric vehicle charging control device 100 may be configured to check the current temperature of the battery 140 through information on the current temperature of the battery 140 output from the temperature sensor 120 (i.e., temperature information, T)

In step S450, the electric vehicle charging control device 100 may be configured to determine whether the temperature information (T) is less than the preset first threshold temperature (Tₜₕ₁). For example, in the electric vehicle charging control information 200 illustrated in FIG. 2, the first threshold temperature (Tₜₕ₁) may be (a+13) degrees.

In step S455, when it is determined that the temperature information (T_{b}) is less than the preset first threshold temperature (Tₜₕ₁), the electric vehicle charging control device 100 may be configured to provide a current corresponding to the battery 140 using the voltage of the battery 140, the temperature information (T) and/or the electric vehicle charging control information 200. Accordingly, the battery 140 may be quickly charged. Thereafter, the electric vehicle charging control device 100 may be configured to reperform the operations from step S420.

In step S460, when it is determined that the temperature information (T) is greater than or equal to the first threshold temperature (Tₜₕ₁), the electric vehicle charging control device 100 may be configured to check whether the temperature information (T_{b}) is less than the preset second threshold temperature (Tₜₕ₂). For example, in the electric vehicle charging control information 200 illustrated in FIG. 2, the second threshold temperature (Tₜₕ₁) may be (a+15) degrees.

In step S465, when it is determined that the temperature information (T) is greater than or equal to the second threshold temperature (Tₜₕ₂), the electric vehicle charging control device 100 may be configured to supply a current corresponding to slow charging to the battery 140. Accordingly, the battery 140 may be slowly charged. Thereafter, the electric vehicle charging control device 100 may be configured to reperform the operations from step S420.

In step S470, when it is determined that the temperature information (T) is greater than or equal to the preset first threshold temperature (Tₜₕ₁) and less than the second threshold temperature (Tₜₕ₂), the electric vehicle charging control device 100 may be configured to provide to the battery 140 the maximum current (Iₘₐₓ-Tₜₕ₂) at which the temperature information (T) is maintained below the second threshold temperature (Tₜₕ₂). Here, the maximum current (Iₘₐₓ-Tₜₕ₂) may be a value previously set experimentally and stored in the memory 130. Alternatively, the maximum current (Iₘₐₓ-Tₜₕ₂) may be the current when the temperature information (T) reaches the second threshold temperature (Tₜₕ₂) after the current supplied to the battery 140 continuously increases when the temperature information (T) is sensed to be greater than or equal to the first threshold temperature (Tₜₕ₁). Thereafter, the electric vehicle charging control device 100 may be configured to reperform the operations from step S420.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but are provided only for the illustrative purpose. The scope of the present disclosure should be construed on the basis of the accompanying claims, and all the technical ideas within the scope equivalent to the claims should be included in the scope of the present disclosure.

What is claimed is:

1. An electric vehicle charging control device, comprising:
a temperature sensor configured to:
sense a temperature of a battery to be charged; and
generate temperature information;
a processor; and
a memory coupled to the processor,
wherein:
the memory is configured to store program commands that are executable by the processor, and
the program commands are configured to cause the processor to perform fast charging of the battery by using a maximum current value that maintains less than a preset second threshold temperature when the temperature information is greater than or equal to a preset first threshold temperature.

2. The device according to claim 1, wherein the program commands are further configured to cause the processor to:
increase a current value set when the temperature information is sensed to be greater than or equal to the first threshold temperature; and
terminate the increase of the current value when the temperature information reaches the preset second threshold temperature.

3. The device according to claim 1, wherein the program commands are further configured to cause the processor to terminate the fast charging when a voltage of the battery reaches a preset cut-off voltage as the battery is quickly charged using the maximum current value.

4. The device according to claim 3, wherein the program commands are further configured to cause the processor to start constant-voltage charging when the cut-off voltage is reached using the maximum current value.

5. The device according to claim 4, wherein the program commands are further configured to cause the processor to start slow charging when a current provided to the battery corresponds to a preset slow charging current after the constant-voltage charging.

6. The device according to claim 1, wherein the program commands are further configured to cause the processor to terminate the fast charging when the temperature information is greater than or equal to the preset second threshold temperature.

7. The device according to claim 6, wherein the program commands are further configured to cause the processor to restart the fast charging when the temperature information becomes less than the preset second threshold temperature.

8. A method for controlling charging of an electric vehicle, performed in an electric vehicle charging control device, the method comprising:
setting a maximum current value that maintains less than a present second threshold temperature when a temperature of a battery to be charged is greater than or equal to a preset first threshold temperature; and
performing fast charging of the battery using the maximum current value.

9. The method according to claim 8, wherein the setting the maximum current value further comprises:
increasing a current value set when temperature information is sensed to be greater than or equal to the first threshold temperature; and
terminating the increase of the current value when the temperature information reaches the preset second threshold temperature.

10. The method according to claim 8, further comprising terminating the fast charging when a voltage of the battery reaches a preset cut-off voltage as the battery is quickly charged using the maximum current value.

11. The method according to claim 10, wherein the terminating the fast charging further comprises starting constant-voltage charging when the cut-off voltage is reached using the maximum current value.

12. The method according to claim 11, wherein the terminating the fast charging further comprises starting slow charging when a current supplied to the battery corresponds to a preset slow charging current after the constant-voltage charging.

13. The method according to claim 8, further comprising terminating the fast charging when temperature information is sensed to be greater than or equal to the preset second threshold temperature.

14. The method according to claim 13, further comprising restarting the fast charging when temperature information is sensed to be less than the second threshold temperature.
